(19) United States
(12) Patent Application Publication
(10) Pub. No.: US 2023/0113578 A1
(43) Pub. Date: Apr. 13, 2023

(54) TRANSACTION AND OWNERSHIP INFORMATION DOCUMENT EXTRACTION

(71) Applicant: American Express Travel Related Services Company, Inc., New York, NY (US)

(72) Inventors: Tarun Kumar, Bengaluru (IN); Himanshu Gupta, Bengaluru (IN); Himanshu Sharad Bhatt, Bengaluru (IN); Rahul Ghosh, Bengaluru (IN); Nikhil K. Jain, Phoenix, AZ (US); Vinodh Kumar Rajagopalan Velayudham, Phoenix, AZ (US)

(21) Appl. No.: 17/534,511

(22) Filed: Nov. 24, 2021

(30) Foreign Application Priority Data
Oct. 12, 2021 (IN) 202141046513

(51) Int. Cl. G06Q 40/02; G06F 16/93

(52) U.S. Cl. CPC G06Q 40/025; G06F 16/93

(57) ABSTRACT

Disclosed are various embodiments for extracting transaction and user data from financial documents and formatting the data into a structured format to facilitate a real-time analysis of the extracted data. A user may submit an unstructured formatted financial document with a credit rating request, underwriting request, and/or other type of financial risk assessment request. Text components and a table component are identified according to a structural representation of the document. The text components are analyzed to identify and extract ownership data associated with the user that can be used to verify ownership of the provided document by the submitting user. The transaction data is identified and extracted in a structured format based at least in part on a table header location and detected column boundaries. The extracted transaction data is validated to ensure an accurate extraction of the transaction data.

### CLAIM OF PRIORITY

This application claims priority to provisional Indian Application No. 202141046513, filed Oct. 12, 2021, and entitled “TRANSACTION AND OWNERSHIP INFORMATION DOCUMENT EXTRACTION”, which is incorporated by reference as if set forth herein in its entirety.

### BACKGROUND

Bank statement extraction provides financial organizations access to a customer's financial well-being for credit ratings and under-writings. Most organizations analyze bank statements either manually or with a cloud or vendor-based solution to extract relevant information from bank statements in a structured format. These approaches have limitations that restrict their wide-scale adoption in financial organizations. Manually analyzing hundreds of bank statements with multiple layouts and formats require costly manual resources, is time-consuming and error-prone. Cloud-based solutions are generic and require customization for specific business needs. Moreover, leveraging cloud-based solutions also includes the data-privacy concerns and associated risks of sharing critical financial information of customers. Vendor-based solutions that combine man and machine approaches may not deliver real-time (or near-real-time) solution and can hamper the overall customer experience.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1C provide example illustrations of a document and the ownership data and the transaction data that can be extracted from the document in accordance of various embodiments of the present disclosure.

FIG. 2 is a schematic block diagram of a networked environment according to various embodiments of the present disclosure.

FIGS. 3A and 3B illustrate examples of text blocks of varying alignment in accordance to various embodiments of the present disclosure.

FIG. 4 is a flowchart illustrating an example of functionality implemented as portions of the document extraction system executed in a computing environment in the networked environment of FIG. 2 according to various embodiments of the present disclosure. In particular, FIG. 4 relates to the functionality associated with analyzing a document and extracting both the ownership data and transaction data for ownership verification and financial risk analysis.

FIG. 5 is a flowchart illustrating an example of functionality implemented as portions of the document extraction system executed in a computing environment in the networked environment of FIG. 2 according to various embodiments of the present disclosure. In particular, FIG. 5 relates to the functionality associated with extracting transaction data from a document in a structured format for financial risk analysis.

FIG. 6 is a flowchart illustrating an example of functionality implemented as portions of the document extraction system executed in a computing environment in the networked environment of FIG. 2 according to various embodiments of the present disclosure. In particular, FIG. 6 relates to the functionality associated with extracting ownership data from a document and verifying ownership of the user based at least in part on the extracted ownership data.

### DETAILED DESCRIPTION

Disclosed are various approaches for extracting transaction and user data from financial documents (e.g., bank statements) and formatting the data into a structured format to facilitate a real-time analysis of the extracted data. In one or more examples, a user may submit a bank statement (or other type of financial document) with a credit rating request, underwriting request, and/or other type of financial risk assessment request. A financial institution may analyze the bank statement to help satisfy the financial risk assessment request. According to various embodiments, the document extraction system of the present disclosure extracts the relevant information from the provided documents into a structured format using an automated and efficient technique. In the example of bank statements, the document extraction system of the present disclosure is able to identify and extract ownership details, financial summary notes, and transactional level details, which are in turn used to identify a financial risk associated with the document owner.

Validating ownership details and extracting the transactional information are important factors in bank-based underwriting, which is applied across multiple touchpoints in an account holder's life cycle. For example, bank-based underwriting is important for managing (increasing or decreasing) credit limits for the customers, new accounts, transaction classification, and bank risk index to capture the holistic financial health of a particular customer. According to various embodiments, the present disclosure helps mitigate the risk of financial loss, reduce operational expenses, and preserve the reputation of protecting customers and their interests.

Traditional document extraction techniques have limitations that restrict wide-scale adoption in financial organizations. For example, manual analysis of bank statements with multiple layouts and formats requires costly manual resources and is time-consuming and error-prone. Cloud-based solutions are generic and require customization for specific business needs. Moreover, leveraging cloud-based solutions also includes the data-privacy concerns and associated risks of sharing critical financial information of customers. Vendor-based solutions that combine manual and machine approaches may not deliver real-time (or near-real-time) solutions and can hamper the overall customer experience. Accordingly, it can be beneficial to provide an automated solution that can efficiently extract the relevant information from bank statements with varying and changing document structures and formats to overcome the limitations of the traditional techniques.

According to various embodiments, the document extraction system of the present disclosure leverages an automated and efficient technique to extract the relevant information from financial documents (e.g., bank statements) into a structured format. In addition, the document extraction system is able to identify and extract transaction and user data from financial documents of varying formats and geometric structures. In particular, the document extraction system of the present disclosure provides a robust extraction system that is effective at extracting the relevant transaction and ownership data in documents that may change in structure over time. In various examples, the present disclosure presents a two-stage technique to process documents, identify different components within the documents, and extract the relevant information from the different components of the documents.

To begin, the document extraction system of the present disclosure parses a document (e.g., bank statement) to determine a geometric structure of the document and identify candidate regions from the document that could contain transactional data or other relevant information about the document. According to various examples, one stage of the extraction technique of the present disclosure includes identifying candidate regions comprising transaction tables and processing the transaction data from the detected transaction table component into a structured format designed to facilitate real-time (or near real-time) analysis. Upon identifying a document component that corresponds to a transaction table, the table header and column boundaries of the transaction table are identified. The table header location and column boundary data enhances the performance of a table parsing library (e.g., CAMELOT) that traditionally fails to identify the beginning and the end of tables efficiently. In various examples, rows spanning across multiple lines are processed using the structural geometry of the tabular data. The transaction data can then be processed to create a cohesive form by removing duplicate entries, cleansing row and column data, and detecting transaction chronology. According to various examples, self-testing is conducted to detect any errors in the spreading process.

Another stage of the extraction technique of the present disclosure includes identifying candidate regions comprising text blocks and extracting the ownership details and account summary details from the text blocks of the document. In particular, the text blocks may include fields related to an account number, owner name, owner address, statement period, currency, opening balance, closing balance, and/or other type of ownership or account summary details. According to various embodiments, the ownership and account summary details are identified and extracted according to labeled extraction and unlabeled extraction. Labeled extraction entails the retrieval of key-value pairs from documents. For example, an account number may be identified by a label of “Account Number” included in the document. For the information being marked with a corresponding label, the document extraction system of the present disclosure leverages structural and positional alignment to extract the information as structured key-value pairs.

Unlabeled extraction includes an analysis of the text to identify and extract information that is “unlabeled” (e.g., not in the form of key-value) in the document. This information may include an owner address, an owner name, a statement period, and/or other type of information that may not be explicitly labeled in the document. In various examples, unlabeled text can be analyzed using Named Entity Recognition (NER) to identify relevant entities such as date, location, person, organization, etc. Upon extracting the user and account summary details, ownership of the user can be verified according to a real-time analysis of the extracted information. Therefore, if a user provides an incorrect document that does not appear to be owned by the user, the user can be promptly notified of the error. This can improve the overall customer experiences since the customer can be notified of an error associated with the document in real time (or near real time) instead of waiting multiple days to be notified of the potential issue.

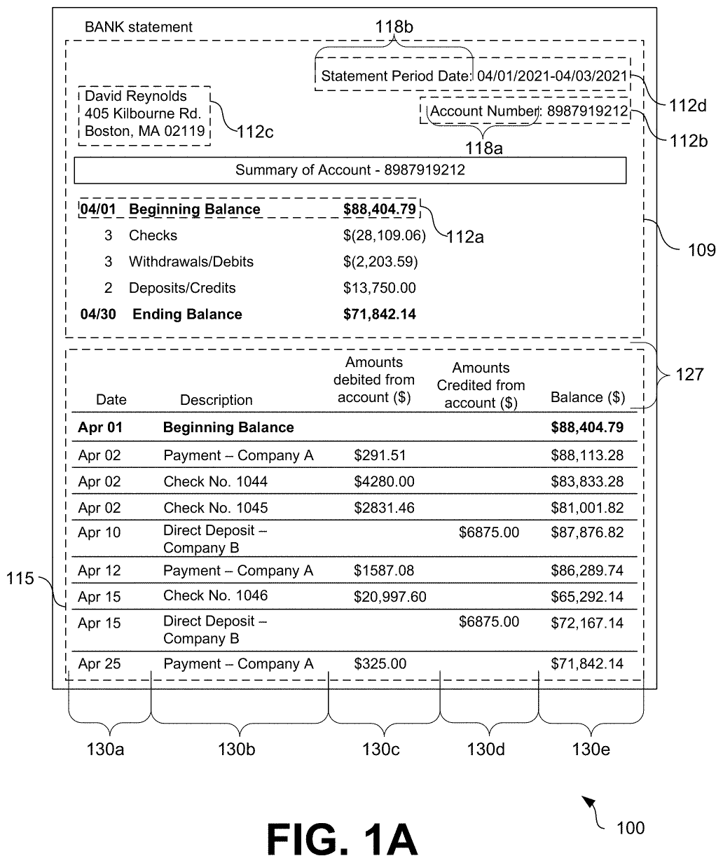

FIGS. 1A-1C provide example illustrations of a document 100 and the ownership data 103 and the transaction data 106 that can be extracted from the document 100 in accordance of various embodiments of the present disclosure. In particular, FIG. 1A illustrates an example financial document 100 (e.g., bank statement) that can be provided by a user with respect to a financial risk assessment. According to various examples, the document 100 can comprise a portable document format (PDF) document and can include transaction details and ownership information associated with a given transaction account. In the example of FIG. 1A, a first section 109 of the document 100 includes a plurality of text components 112 (e.g., 112a, 112b, 112c, 112d) that include user details and account summary details. A second section of the document 100 includes a table component 115 that includes a table of data corresponding to transactions associated with the account.

According to various embodiments, the text components 112 can be analyzed to identify and extract the ownership data 103 that is illustrated in FIG. 1B. As shown in FIG. 1A, some of the ownership data 103 (e.g., the account number, the beginning balance, the statement period date) includes explicit labels 118 that can be used to identify the type of ownership information while other ownership data 103 (e.g., owner name, owner account number) fails to include labels 118 identifying the type of ownership information. According to various examples, the labeled ownership data 103 is extracted by identifying and retrieving the key-value pairs from the document 100. The unlabeled ownership data 103 can be extracted following an analysis of the text (e.g., named entity recognition) to identify named entities in the text. Upon identifying the different text entities, the unlabeled data can be assigned a score based at least in part on the associated entities. The score can be used to predict the type of ownership information the unlabeled text is associated with. As illustrated in FIG. 1B, a key 121 corresponds to the type of information and the value 124 corresponds to the text associated with the type of information.

FIG. 1C illustrates an example representation of the transaction data 106 that is extracted from the table component 115 included in the document 100 in accordance to various embodiments. In various examples, table structure features are identified following detection of the table component 115 within the document 100. For example, a location of a table header 127 (FIG. 1A) can be determined according to an analysis of the text terms (e.g., date, description, amounts debited, amounts credited, balance, etc.) in the table component 115. In addition, column boundaries associated with each of the table columns 130 (e.g., 130a, 130b, 130c, 130d, 130e) (FIG. 1A) can be determined. With the knowledge of the table structure features, the transaction data 106 can be extracted from the document and the data can be formatted in a structured format for analysis to understand a financial risk associated with a user. In various examples, the structured format can comprise a spreadsheet, a comma-separated values (CSV) document, a hypertext markup language (HTML) document, an extensible markup language (XML) document, and/or other type of structured format. In addition, the transaction data can be validated to ensure an accurate identification and extraction of data from the table component 115.

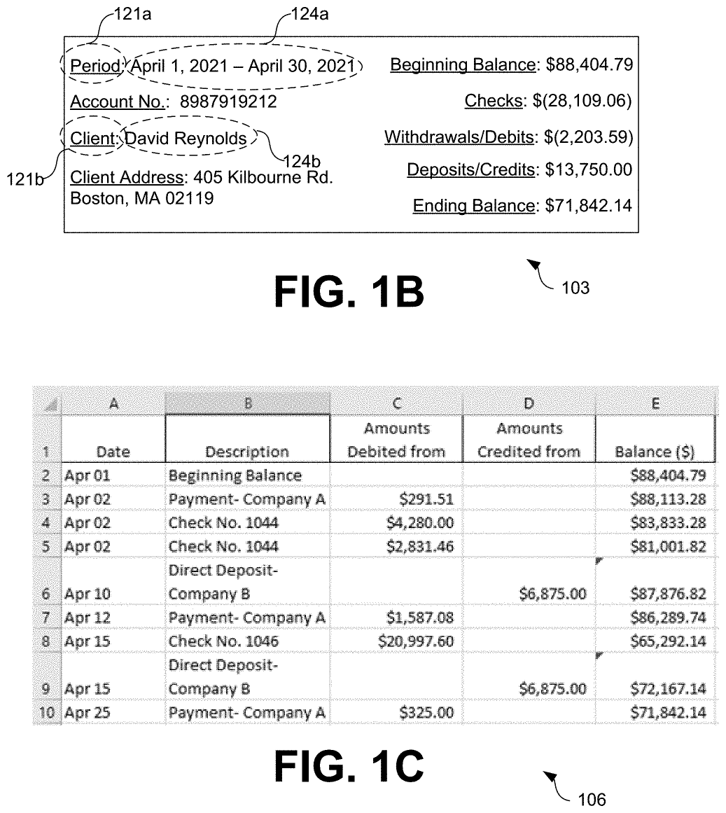

Turning now to FIG. 2, shown is a networked environment 200 according to various embodiments. The networked environment 200 includes a computing environment 203 and one or more client devices 206, which are in data communication with each other via a network 209. The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource, and/or any other distributed computing arrangement. In some cases, the computing environment 203 may correspond to an elastic computing resource where the allotted capacity of processing, network, storage, or other computing-related resources may vary over time. In various examples, the computing environment 203 corresponds to an issuer system associated with an issuer of payment or other types of financial accounts for users.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include a document extraction system 215, a financial assessment engine 218, and other applications, services, processes, systems, engines, or functionality not discussed in detail herein. The document extraction system 215 is executed to analyze documents 100 provided by client devices 206 associated with users requesting a financial health assessment. According to various examples, the document extraction system 215 comprises a document parser for parsing the document 100 to identify structured text and to generate a structured representation of the provided document 100. Upon generating a structured representation of the document 100, the document extraction system 215 identifies document components within the document 100. According to various examples, the document components can comprise text components 112, one or more table components 115, and/or other type of document component. A text component 112 comprises one or more blocks of text within the document and a table component 115 comprises a table.

The document extraction system 215 analyzes the text components 112 to identify and extract ownership data 103 (e.g., owner name, owner address, statement period, opening balance, closing balance, etc.) from the text components 112. According to various embodiments, the user and account summary details included in the ownership data 103 are identified and extracted according to labeled extraction and unlabeled extraction. Labeled extraction entails the retrieval of key-value pairs from a document 100. For the information being marked with a corresponding label 118 (e.g., key 121), the document extraction system 215 leverages structural and positional alignment to extract the information as structured key-value pairs. Unlabeled extraction includes an analysis of the text within a corresponding text component 112 to identify and extract information that is “unlabeled” (e.g., not in the form of key-value) in the document. This information may include an owner address, an owner name, a statement period, and/or other type of information that may not be explicitly labeled in the document.

In various examples, the document extraction system 215 applies Named Entity Recognition (NER) to identify relevant entities such as date, location, person, organization, etc. Upon identifying the different text entities, the unlabeled data (e.g., candidate text block) can be assigned a score based at least in part on the associated entities identified. The score can be used to determine a likelihood that the candidate text block (e.g., unlabeled text) corresponds to a given key 121 (e.g., the type of ownership information associated with the unlabeled text). According to various examples, the document extraction system 215 applies the document extraction rules 221 to identify and extract the labeled and unlabeled text from the text components 112. In various examples, the document extraction rules 221 can include a set of keywords corresponding to each of the types of keys 121. As such, when one or more terms included in the unlabeled text match one or more keywords included in the set of keywords for a given key 121, a likelihood that the unlabeled text corresponds to the given key 121 increases.

In various examples, the document extraction system 215 compares the extracted ownership data 103 (including the account summary data) with the user data 227 to determine if the details extracted from the document 100 match the details included in the user data 227. In one or more examples, if the extracted ownership data 103 matches the user data 227, the document extraction system 215 sends a notification to the client device 206 associated with the user indicating that the documents 100 have been verified. However, if the extracted ownership data 103 fails to match the user data 227, the document extraction system 215 sends a notification to the client device 206 associated with the user indicating that the documents 100 could not be verified.

In one or more examples, the document extraction system 215 analyzes the one or more table components 115 to identify and extract transaction data 106 included in the table components 115. In various examples, the document extraction system 215 applies the document extraction rules 221 to identify the table structure including the table header location of the table header 127 as well as the column boundaries defining each column that corresponds to a given table header entry within the table header 127. The document extraction system 215 determines the geometric table structure and applies the geometric table structure parameters with a table parsing library that may be included in the document extraction rules 221, stored separately in the data store 212, or accessed via the network 209 to extract the transaction data 106 included in the table component 115 in a structured format. Upon extracting the transaction data 106 from the document 100, the document extraction system 215 post-processes the data. Post processing the data can include organizing transaction types, managing multi-page tables, removing duplicate tables, merging multiline rows within the table, and/or other type of post processing to ensure the extracted transaction data 106 is properly formatted in the structured format.

In various examples, the document extraction system 215 validates the extracted transaction data to ensure that the transaction data 106 was properly extracted. In some examples, the document extraction system 215 identifies an opening balance and a closing balance from the extracted transaction data 106 or the extracted ownership data 103. In this example, the document extraction system 215 can add the sum of all credit values included in the extracted transaction data 106 and subtract the sum of all debit values included in the extracted transaction data 106 from the opening balance to determine a predicted closing balance. If the predicted closing balance matches the previously determined closing balance, the extraction of the transaction data 106 is verified.

The financial assessment engine 218 is executed to analyze the extracted transaction data 106 to determine a financial health of a particular user. In one or more examples, the extracted transaction data 106 can be used as a factor in an overall analysis of a user's financial health to determine a financial risk associated with the user. For example, the financial assessment engine 218 can analyze the descriptions and transaction amount associated with each transaction included in the transaction data 106 and score each transaction based at least in part on the transacting parties, the amount of the credit value, the amount of the debit value, the number of transactions, and/or other factors. The financial risk can be used to determine the result of an underwriting request, credit rating request, and/or other type of financial risk assessment.

The data stored in the data store 212 includes, for example, user data 227, documents 100, extracted ownership data 103, extracted transaction data 106, document extraction rules 221, and potentially other data. The user data 227 corresponds to information related to individuals who have been issued and/or have requested payment accounts by an issuer associated with the computing environment 203. A payment account can represent any financial account or agreement that a customer can use as a source of funds for payments. Payment accounts can include both credit accounts or facilities and financial deposit accounts that provide the owner with on demand access to funds stored in or associated with the payment account. In some instances, a payment account can allow a user to have frequent and/or immediate access to funds. In these instances, payment accounts can also be referred to as demand deposit accounts, which can be accessed in a variety of ways, such as the use of debit cards, checks, or electronic transfers (e.g., wire transfer, automated clearing house (ACH) transfer, etc.). Examples of payment accounts include charge or charge card accounts, credit or credit card accounts, checking accounts, savings accounts, money market accounts, demand accounts, deposit accounts, demand deposit accounts, etc.

The user data 227 includes payment instrument data, transaction history data (e.g., a transaction amount, a transaction merchant, a date of transaction, a mode of transaction authentication, a mode of transaction, transaction location information), account address(es), account holder name, account holder contact information, authentication information, and/or other data associated with a user or user account provided by the issuer. The payment instrument data can correspond to data associated with payment accounts provided by an issuer associated with of the computing environment 203. For example, the payment instrument data can comprise data describing credit card accounts, debit card accounts, virtual cards, charge card accounts, and/or other mechanisms for effecting a payment with respect to a transaction account provided by the issuer and associated with the user of the client device 206. For example, for a credit card account or a charge card account, the payment instrument data can store a card number, a cardholder name, an expiration date, a verification code, a billing address, and/or other information needed to consummate a payment.

A document 100 comprises a document provided by a user interacting with the financial assessment engine 218 and/or document extraction system 215 with respect to a financial risk assessment request. In various examples, the document 100 comprises a bank statement and/or other type of financial document that can provide details related to a user's financial history. In various examples, the document 100 comprises a portable document format (PDF) document.

The extracted ownership data 103 includes the data extracted from the text components 112 identified in the document. In various examples, the extracted ownership data 103 includes an owner name, an owner address, an issuer name, an issuer address, a statement period, a beginning balance, a closing balance, an account number, a total credit value, a total debit value, and/or other data that can be extracted from the text components 112 of the document 100. In various examples, the extracted ownership data 103 is organized in key-value pairs where a key 121 corresponds to the type of information extracted (e.g., “account number”) and the value 124 corresponds to the text associated with the type of information (e.g., 8987919212). In one or more examples, a key 121 may be explicitly included in the document 100 as a text label 118 in association with a value 124. In other examples, the key 121 associated with a value 124 that is included in the document 100 is inferred according to an analysis of the text.

The extracted transaction data 106 comprises the data that is extracted from the table component 115 corresponding to a transaction table. According to various examples, transaction data 106 can be extracted from the document 100 and formatted in a structured format for analysis to facilitate an understanding of a financial risk associated with a user. In various examples, the structured format can comprise a spreadsheet, a comma-separated values (CSV) document, a hypertext markup language (HTML) document, an extensible markup language (XML) document, and/or other type of structured and/or delimited format.

The document extraction rules 221 include rules, models, keyword data, and/or configuration data for the various algorithms or approaches employed by the document extraction system 215. For example, the document extraction rules 221 may include the various models and/or algorithms used by the document extraction rules 221 to detect document components in a provided document, extract the transaction data 106 and the ownership data 103 from the document components, and format the extracted data in a formatted structure. In various examples, the document extraction rules 221 include table parsing libraries that can be used to extract the table included in the table component 115 into a structured format. In some examples, the table parsing libraries correspond to an open-source table parsing library (e.g., CAMELOT).

In some examples, the document extraction rules 221 include predefined sets of keywords of commonly used keywords that can be found in the particular type of document 100 being analyzed. For example, bank statements typically include terms such as “account name,” “balance, credit,” “debit,” and/or other types of terms. In various examples, one or more keywords in a set of keywords may be mapped to a particular key 121. In addition, the one or more keywords mapped to a particular key 121 may include one or more synonyms.

The client device 206 is representative of a plurality of client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 206 may include a display 230. The display 230 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 233 and/or other applications. The client application 233 may be executed in a client device 206, for example, to access network content served up by the computing environment 203 and/or other servers, thereby rendering a user interface 236 on the display 230. To this end, the client application 233 may comprise, for example, a browser, a dedicated application, etc., and the user interface 236 may comprise a network page, an application screen, etc. The client device 206 may be configured to execute applications beyond the client application 233 such as, for example, email applications, social networking applications, word processors, spreadsheets, and/or other applications.

Next, a general description of the operation of the various components of the networked environment 200 is provided. To begin, a user interacting with a user interface 236 associated with the computing environment 203 can submit one or more documents 100 associated with a financial risk assessment request. For example, the computing environment 203 can correspond to an issuer system, and the user can submit the one or more documents 100 with a financial risk assessment request in order to apply for a transaction account or loan with the issuer of the issuer system. In various examples, the document 100 comprises a PDF document. Upon receipt of a document 100, the document extraction system 215 analyzes the document 100 to identify and extracts ownership data 103 and transaction data 106 from the document 100.

According to various examples, the document extraction system 215 initially parses the document 100 to obtain structured text from the document 100 and to generate a structured representation of the document 100. Next, the document extraction system 215 analyzes the document 100 to identify document components within the document 100. According to various examples, the document components can comprise text components 112 (e.g., text blocks), one or more table components 115, and/or another type of document component. According to various examples, the ownership data 103 that can be used for ownership verification that is extracted from the text components 112 in one stage and the transaction data 106 is extracted from the one or more table components 115 in another stage. The following provides examples explaining how the document extraction system 215 identifies and extracts the ownership data 103 and the transaction data 106 following the identification of the document components.

### Ownership Extraction

According to various embodiments, the document extraction system 215 extracts ownership data 103 from the text components 112 of the document 100. In various examples, the ownership data 103 can be valuable with respect to ownership verification. For example, bank-based underwriting is used for several credit and risk decisions, including new accounts or credit increase applications. Effectively verifying a client's identity based on a provided document 100 (e.g., bank statement) can mitigate the risk of financial loss, operational expenses and protect brand reputation.

According to various embodiments, the document extraction system 215 of the present disclosure provides an efficient technique to extract the ownership data 103 from a document 100 having text fields corresponding to an account number, an owner name, an owner address, a statement period, a currency, an opening balance, a closing balance, and/or other types of text fields associated with the owner or account summary. The document extraction system 215 applies a labeled extraction technique and an unlabeled extraction technique to extract the ownership data 103 that can be useful for ownership verification.

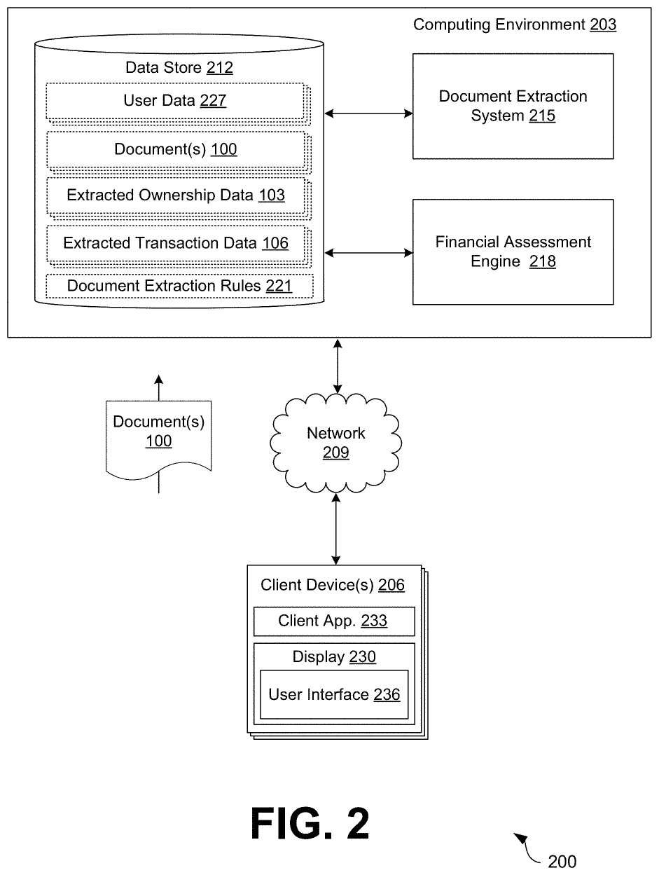

Labeled Extraction: According to various examples, labeled extraction entails the retrieval of key-value pairs from bank statements or other types of documents 100. For labeled extraction, the document extraction system 215 exploits the positional alignment of the structured text block components 112 to create six mappings. Three of the mappings are based on horizontal coordinates (e.g., left, right, and center) and three of the mappings are based on vertical coordinates (e.g., top, bottom, and middle). The horizontal mappings group all of the text blocks that are left, right or center aligned, whereas the vertical mappings group all of the text blocks that are top, bottom, or middle aligned. FIGS. 3A and 3B illustrate examples of text blocks of varying alignment in accordance to various embodiments. For example, FIG. 3A illustrates an example 300a depicting a left alignment (e.g., between “Account Number” and “30798798”). FIG. 3B illustrates an example 300b depicting a top alignment (e.g., between “Account Number” and “30798798”).

Upon determining the positional alignment of the text components 112, the document extraction system 215 identifies and retrieves key-value pairs. A key 121 (FIG. 1B) corresponds to the type of information and the value 124 (FIG. 1B) corresponds to the text associated with the type of information. In the example of labeled data, the key 121 corresponds to the label 118 (e.g., “Account Number”) that is included in the document 100 and the value 124 corresponds to the text defining the account number.

To begin the key-pair retrieval, the document extraction system 215, first identifies the keys 121 (e.g., labels 118) and then fetches the values 124 from the key's neighborhood. According to various examples, a key 121 is identified by comparing the document text with keywords that are common in the type of document 100 (e.g., bank statement) that is being evaluated. For example, the keywords associated with a key 121 for “account number” may include “account no.”, “account #”, “account number”, or other variations.

In various examples, the document extraction system 215 determines a key's coordinates in response to finding a match between text in a text block (e.g., a label 118) and a given keyword. Upon determining a key's coordinates, the document extraction system 215 fetches text blocks aligned to it from the six different mappings. In bank statements, values typically lie either to the right or below the keys. Thus, the document extraction system 215 selects text blocks obeying this constraint.

According to various examples, the document extraction rules 221 includes rules that are applied by the document extraction system 215 to search for values 124 associated with different types of keys 121. For example, the rules can include:

The account number should either have at-least six (6) digits or at-least three (3) “X”s followed by 3 digits. It should not contain decimal points or currency symbols (“$”, “e”, etc.).

For the owner name, Named Entity Recognition (NER) is applied to detect “person”/“organization” and optionally check the presence of company abbreviations (“ltd.”, “llc”, “inc”, etc.) in corresponding text blocks.

The opening and closing balance keys are cleaned to remove commas and “+”/“−” symbols (generally used to denote positive/negative balance). They should contain a valid amount (e.g., some digits followed by a decimal point, followed by exactly two digits). The currency should be mentioned as a three letter word, all in uppercase (e.g., “USD”, “AUD”, “EUR”, etc.). Since, any 3-letter sequence cannot be declared as a currency, the document extraction system 215 can search in a database of currency abbreviations to filter out the positive cases.

Once all key-value pairs are identified and extracted, the key-value pairs are added to extracted ownership data 103 such that the keys 121 are associated with the corresponding value 124.

Unlabeled Extraction: According to various examples, unlabeled extraction includes an analysis of the document text to identify and extract information that is “unlabeled” (e.g., not in the form of key-value) in the document 100. This information may include an owner address, an owner name, a statement period, and/or other type of information that may not be explicitly labeled in the document 100. In various examples, unlabeled text can be analyzed using Named Entity Recognition (NER) to identify relevant entities such as date, location, person, organization, etc. The following provides examples for identifying and extracting ownership data 103 associated with an owner address, an owner name and a statement period using unlabeled extraction.

Owner Address: In a bank statement, the owner address is typically not identified with a label 118. As such, for identification and extraction of an owner address, the document extraction system 215 applies NER on each text component 112, sums up the frequencies (“entity count”) of the various entities (e.g., person, organization, location), and checks the presence of company abbreviations such as “ltd.”, “llc”, “inc”, etc. In various examples, the document extraction system 215 tags all the words in the text component 112 into address components (such as street name, zip code, city, etc.). For example, the document extraction system 217 may invoke a “usaddress” library or other type of address parsing library to tag the words into address components. Once the words are tagged into address components, the document extraction system 215 can apply the document extraction rules 221 to identify and extract various key-value pairs for unlabeled values 124. For example, document extraction rules 221 can include the following:

Increase the entity count by 1 if any company abbreviation is found.

The final entity count should be greater than 1.

A valid address should contain more than just the recipient component.

If multiple candidates for an owner address are identified after leveraging the above rules, the document extraction system 215 can score each candidate according to the entity count and can rank each candidate in a decreasing order of scores. The candidate with the highest score can be declared the owner name and can be associated with the key 121 for “owner name” in the extracted ownership data 103. In some examples, a document 100 may include a bank address and an owner address. However, the document extraction system 215 may remove the bank address from the candidates associated with the owner address by determining whether the term “bank” is included in the address.

Owner Name: If the “owner name” is not present as a labeled key, the value 124 is generally present at the top of the owner address. Therefore, once the owner address candidates are identified, the owner name value 124 for the owner name key 121 can be determined by a person/organization entity that is identified during the named entity recognition analysis. However, in some examples, a person/organization entity may not be identified in an owner address candidate text component 112. In situations where a person/organization entity is not identified, the document extraction system 215 identifies the owner name by extracting the owner name value 124 according to an identification of a company abbreviation or recipient during a NER analysis of the text components 112.

Statement Period: The statement period is generally present in documents 100 as an unlabeled phrase. To identify the statement period, the document extraction system 215 analyzes the structured text output of the initial parsing of the document 100 to search for connector words or symbols (e.g., “to”, “through”, “-”) which typically links potential start period and end period strings. Upon identifying a connector word or symbol, the document extraction system 215 scans both sides of the connector and verifies whether dates can be extracted. In various examples, the document extraction system 215 can use a date parser package or library to efficiently search for a variety of date patterns and return the optimal date. If a valid date is extracted on both sides, the date on the left is associated with the start period and the date on right is associated with the end period. In various examples, statement periods spanning multiple-lines can be determined according to the alignment mappings discussed with regard to the labeled extraction.

Extracting the above fields (e.g., owner name, owner address, statement period) is useful for bank ownership verification and can also be utilized in bank transactions extraction. For financial applications, clients usually submit documents 100 (e.g., statements) for multiple months spread across multiple documents. According to various examples, the document extraction system 215 can extract the account number and statement period information from every document 100 to automatically combine transactions for every account, in the chronological order.

In various examples, once the ownership data 103 is extracted, the document extraction system 215 compares the extracted ownership data 103 with the user data 227 to determine if the details extracted from the document 100 match the details included in the user data 227. In one or more examples, if the extracted ownership data 103 matches the user data 227, the document extraction system 215 generates and sends a notification to the client device 206 associated with the user indicating that the documents 100 have been verified. However, if the extracted ownership data 103 fails to match the user data 227, the document extraction system 215 generates and sends a notification to the client device 206 associated with the user indicating that the documents could not be verified.

### Bank Transaction Extraction

According to various embodiments, the document extraction system 215 identifies and extracts the transaction data 106 from the table component 115. In one or more examples, the document extraction system 215 uses a table parsing library to extract the associated text from the document 100. For example, the table parsing library can comprise an open-source table parsing library (e.g., CAMELOT). However, since there are several limitations that restrict the applicability of the traditional table parsing techniques for efficient extraction of the transaction details, the document extraction system 215 of the present disclosure provides additional document structure analysis and processing to make the transaction extraction of a document 100 more robust than traditional table parsing techniques and generic techniques across different templates and layouts.

Header Detection: Traditional table parsing techniques are limited in their inability to identify the start and end of the table. According to various embodiments, the document extraction system 215 identifies a header 127 and header start location of a transaction table included in a transaction table component 115. In particular, the document extraction system 215 identifies the header 127 and the header start location on a particular page of the document 100. In one or more examples, the document extraction system 215 analyses the text in the transaction table to identify patterns where commonly used header keywords (e.g., ‘Date’, ‘Description’, ‘Debit’, ‘Credit’, ‘Balance’) appear together on the same horizontal line. In various examples, the document extraction system 215 can match the corresponding column header term for each column 130 to one or more keywords that are known to be synonyms. For example, the column header term for a “debit” column 130 may include the term ‘debits’, ‘withdrawals’, and/or another type of synonymous keyword.

In various examples, the document extraction system 215 extracts the text included in the table component 115 line by line and matches the table text against the common header expressions and/or keywords. In various examples, a text line corresponds to text elements having roughly the same y-coordinate and the same font styling information. This process leads to a mapping from a column header term to the index at which it occurs. For example, if a detected header line includes the following sequence ‘Date’, ‘Description’, ‘Deposits’, ‘Withdrawals’, ‘Balance’, then ‘date’ will be assigned the 0th index, “description” will be assigned the 1st index and so on. In some examples, a header 127 can span across multiple lines. In this scenario, the document extraction system 215 considers the group of lines together to judge the presence of a header 127 and then, based on the analysis, creates a mapping between index values and header terms.

In various examples, bounding box coordinates of the table header 127 are input into a table parsing library that transforms the table into a data structure suitable for downstream algorithmic processing. In various examples, the table parsing library comprises an open-source table parsing python library (e.g., CAMELOT). The positional information corresponding to the header location within the document 100 considers how a typical document 100 (e.g., bank statement) looks (e.g., the account summary details at the top with the transaction table below) and helps to localize and detect the transaction table better rather than just relying on the raw output of the library.

Column Separator Estimation: After the header 127 is detected in the transaction table, the document extraction system 215 estimates the column boundaries for each column 130. A column boundary corresponds to the boundaries defining the horizontal start and end of a column 130. Although column boundaries can be determined by taking the left and right endpoints of the column headers, this can fail if a column 130 is wider than the column headers, which is common with columns 130 corresponding to the transaction description. To overcome this limitation, the document extraction system 215 estimates the inherent alignment of the text under each of the column headers and then calculates the minimum of all left endpoints and maximum of all right endpoints for a particular column 130. Accordingly, the calculated dimensions are used as the width of the column 130.

For some documents 100, the close placement of neighboring columns 130 can cause text extraction tools to inadvertently merge the cells which lie close to each other on the x-axis. This potentially can cause these merged cells to span across multiple columns 130, which can hinder the application of the above technique. According to various examples, the document extraction system 215 of the present disclosure identifies these types of merged cells and ignores these cells for the width computation.

Table-to-structured format: According to various embodiments, the document extraction system 215 uses an interactive process for table detection that involves two calls to the table parsing library in the document extraction rules 221. For the first call, the document extraction system 215 invokes the table parsing library to parse the table included in the table component 115 and observes the table boundaries (e.g., a predicted table) provided by the table parsing library. In the second call, the document extraction system 215 provides the detected table headers 127, a computed table bottom, and the column boundaries to the table parsing library which will output a table in a structured format.

In various examples, the table beginning can be detected according to the header information, but the same does not hold for the bottom of the table. Specifically, the document extraction system 215 estimates the table bottom by considering the fact that the numeric columns 130 (e.g., “debit,” “credit,” and “balance”) should either be empty or contain a numerical value. The line where this invariant ceases to be true is taken as the estimate of the table end.

Upon obtaining one or more tables from the table parsing library, the document extraction system 215 filters the detected tables based on three criteria. First, the predicted table should have its top at or above the estimated table top. Second, the table bottom should be below the computed table top. Third, if multiple tables satisfy the above criteria, the document extraction system 215 removes any duplicate tables.

According to various examples, if the table parsing library fails to detect any tables, the document extraction system 215 uses the estimated table top and bottom coordinates for the table. Once the table structure is determined, the detected table is formatted into a structured format by passing the table header and bottom information as the table bounding box along with column boundary information to the table parsing library.

Duplicate Table Detection: In various examples, the need for duplicate table detection arises when the table parsing library produces two or more tables with slightly shifted x-coordinates or y-coordinates, which leads to redundant detected tables for the same original table. To solve this issue, the document extraction system 215 employs non-maximum suppression which is a technique in object detection where multiple predicted bounding boxes for the same ground truth object are suppressed. To begin, the document extraction system 215 sorts the predicted bounding boxes in descending order of accuracy and then computes the intersection-over-union (IoU) of the current most accurate box with the remaining boxes. If the IoU is more than some threshold, the document extraction system 215 discards those boxes and saves the current one. This process is repeated until only the unique bounding boxes remain. The duplication table diction and removal process helps localize the transaction tables uniquely even in the scenarios where one fails to detect headers on a page or when a table rolls over to subsequent pages.

Merge Multi-line Rows: Transaction descriptions are a core part of bank statements which include information such as the recipient/sender of amount, the mode of transaction, charges/fees, and/or other information that may be included in a transaction description. To display this information in a structured manner, majority of the issuers provide the information across multiple lines to make it readable to the customer. If only the first line of the description is considered, the document extraction system 215 can miss out on important information about the actual transaction. Automated solutions built on top of these incomplete descriptions may give spurious analytical results due to this partial loss of information. Thus, there is a need to identify transaction descriptions spanning across multiple lines so as to map them to the original transaction. According to various embodiments of the present disclosure, the document extraction system 215 detects multi-line transaction rows and merges the detected rows to appropriate map the detailed information to the appropriate transaction.

Before computing the demarcations of where one transaction ends and the other begins, the document extraction system 215 removes spurious lines that may have entered into the structured output. For example, the document extraction system 215 remove lines which have a valid date but an invalid numerical value in the numerical columns. In another example, the document extraction system 215 removes lines which may or may not contain a legitimate numerical value if the description field is empty. Next, the document extraction system 215 trims off the “balance” lines (e.g., the lines which contain phrases such as “Opening balance”, “Closing Balance”, “Balance Brought Forward”, “Balance Carried Forward”) since these lines are seldom placed differently in the transaction table when compared to the “actual” transactions.

In various examples, while extracting the table as discussed above, the document extraction system 215 records the coordinates of every line. In various examples, the document extraction system 215 exploits the “space” between two lines to judge the presence of a transaction row separator. For this, the document extraction system 215 calculates a difference array which contains the vertical (y-axis) difference between adjacent lines. The document extraction system 215 makes use of several invariants and four rules to estimate these separators. The invariants which are true for every bank statement are—Every transaction should have a valid numerical value (either debit or credit) and the number of transactions should be equal to the number of such numerical values in the whole table. Consider three consecutive values in the difference array as x, y, z (in the chronological order). Any difference d is between lines L_{d} and U_{d}, where U_{d} is the greater value on y-axis. The four rules are provided as follows:

Rule 1: If two valid numerical amounts are encountered in two adjacent lines, one after the other, a row separator is declared after the first line.

Rule 2: If y is greater than x and also greater than z by some threshold, a row separator is declared after the line L_{y} of difference y.

Rule 3: If x is greater than z and y is greater than z by some threshold and line Ly has valid numerical value, a row separator is declared after the line L_{y} of difference y.

Rule 4: If y is greater than x and z is greater than x by some threshold and line Uy has valid numerical value, a row separator is declared after the line L_{y} of difference y.

According to various examples, the thresholds are determined according to an analysis of multiple bank statements. Also, before declaring a potential row separator, the document extraction system 215 ensures that the lines from a previous separator to the declared separator contain a valid numerical value. The second invariant is validated by checking whether the number of row separators is one (1) less than the number of legitimate numerical values (e.g., the number of transactions). Finally, all the lines between two consecutive separators are merged and treated as a complete transaction description. In some examples, none of the rules are triggered (e.g., when all lines are equidistant from each other). In these cases, the document extraction system 215 takes the value in the “date” column 130 as the starting of a new transaction and merged all lines up until the next (valid) date.

Self-Validations: Upon formatting the transaction data 106 into a structured format, the document extraction system 215 automatically verifies if the transaction data 106 is extracted correctly. Prior to verifying the transaction data 106, the document extraction system 215 infers the transaction date formats and then the chronology of the transactions. For dates which are not in the abbreviated formats of “dd/mm/yy” or “mm/dd/yy”, the document extraction system 215 uses a date parsing library which extracts the date, month and year information fields.

For the abbreviated date formats, the document extraction system 215 infers whether the format is “date first” or “month first”. In various examples, the document extraction system 215 analyzes the values in the date column and split by “/” or “-” and fetches the first two components. One of components should be month and the other should be day. The document extraction system 215 analyzes the components and determines that a component having a value that is greater than twelve (12) a day and the other component corresponds to the month.

Once the date format is determined, the document extraction system 215 determines the order in which the dates appear in the table. If the dates are in ascending order, the document extraction system 215 determines that the transactions open at the top. Likewise, if the dates are in descending order, the document extraction system 215 determines that the transactions end at the top of the table. In various examples, the chronologically last value in the balance column 130 is assigned as the closing balance (CBt). For example, assume that the transaction amount in the chronologically first transaction is A and transaction balance is B, then B−A is the opening balance if A is a credit or B+A is the opening balance if A is a debit. In this situation, the document extraction system 215 subtracts the sum of all the debits and adds the sum of all credits to the opening balance to compute the predicted closing balance (CBp). The document extraction system 215 verifies that the transaction data was extracted correctly when CBp equals CBt.

According to various examples, the financial assessment engine 218 obtains the extracted transaction data 106 for analysis to determine a financial health of a particular user. In one or more examples, the extracted transaction data 106 can be used as a factor in an overall analysis of a user's financial health to determine a financial risk associated with the user. For example, the financial assessment engine 218 analyzes the descriptions and transaction amount associated with each transaction included in structured format of the transaction data 106 and scores each transaction based at least in part on the transacting parties, the amount of the credit value, the amount of the debit value, the number of transactions, and/or other factors. The financial risk can be used to determine the result of an underwriting request, credit rating request, and/or other type of financial risk assessment.

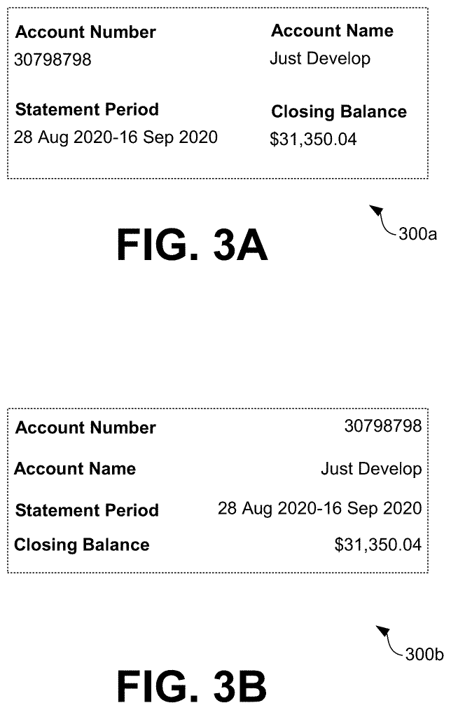

Turning now to FIG. 4, shown is a flowchart 400 that provides one example of the operation of a portion of the document extraction system 215 according to various embodiments. It is understood that the flowchart of FIG. 4 provides merely an example of the many different types of functional arrangements that may be employed to implement the operation of the portion of the document extraction system 215 as described herein. As an alternative, the flowchart of FIG. 4 may be viewed as depicting an example of elements of a method implemented in the computing environment 203 (FIG. 2) according to one or more embodiments.

Beginning with block 403, the document extraction system 215 receives a financial document 100 from a client device 206. In various examples, a user interacting with a user interface 236 associated with the document extraction system 215 and/or another application within the computing environment 203 may submit a request for a financial risk assessment of the user. The request can comprise an underwriting request, a credit rating request, and/or other type of request that requires an analysis of the document 100 in determining a financial health of the user. In various examples, the document 100 is submitted with or in response to the request. In one or more examples, the document 100 comprises a bank statement or other financial document and is uploaded to the client device 206 as a PDF document.

At block 406, the document extraction system 215 parses the financial document 100 to obtain structured text from the document 100 and to generate a structured representation of the document 100. For example, the document extraction system 215 parses the document 100 to identify text within the document 100. In addition, the document extraction system 215 further determines a structured representation of the document 100. For example, the document extraction system 215 identifies locations within document where text appears to determine a structured representation of the document 100.

At block 409, the document extraction system 215 identifies one or more text components 112 and a transaction table component 115 from the document. For example, the document extraction system 215 analyzes the document 100 and the patterns of the structured representation of the document 100 to identify candidate regions from the document 100 that are likely to obtain transactional data 106 and the ownership data 103.

At block 412, the document extraction system 215 extracts the ownership data 103 from the one or more text components 112. In various examples, the ownership data 103 comprises user information and account summary information such as, owner name, owner address, statement period, opening balance, closing balance, and/or other type of user information and account summary information that can be included in the document 100. According to various embodiments, the user and account summary details included in the ownership data 103 are identified and extracted according to labeled extraction and unlabeled extraction. Labeled extraction entails the retrieval of key-value pairs from a document 100. Unlabeled extraction includes an analysis of the text (e.g., named entity recognition) within a corresponding text component 112 to identify and extract information that is “unlabeled” (e.g., not in the form of key-value) in the document 100. For unlabeled text, the associated key 121 is inferred according to the analysis of the text.

At block 415, the document extraction system 215 verifies whether the user submitting the documents is the owner of the document 100 based on an analysis of the extracted ownership data 103. In various examples, the document extraction system 215 compares the extracted ownership data 103 (including the account summary data) with the user data 227 to determine if the details extracted from the document 100 match the details included in the user data 227. For example, the user data 227 can include an owner name and the document extraction system 215 can compare the owner name in the user data 227 with the owner name included in the extracted ownership data 103. If the extracted ownership data 103 fails to match the user data 227, the document extraction system 215 proceeds to block 418. Otherwise, the document extraction system 215 proceeds to block 421.

At block 418, the document extraction system 215 generates and sends a notification to the client device 206 associated with the user indicating that the documents 100 have not been verified. In particular, the document extraction system 215 generates the notification to indicate an error detected with the submitted document. In some examples, the notification can include a request to submit a new document 100. Thereafter, this portion of the process proceeds to completion.

At block 421, the document extraction system 215 extracts the transaction data 106 from the transaction table component 115. According to various examples, the document extraction system 215 analyzes the data in the truncation table component 115 to identify the table header 127 and column boundaries of the transaction table. Upon identifying the table header 127 and column boundaries, the document extraction system 215 invokes a table parsing library including the table header location and column boundaries as inputs. The output of the table parsing library comprises a structured format of the transaction data 106. In various examples, the document extraction system 215 further processes the transaction data 106 to create a cohesive form by removing duplicate entries, cleansing row and column data, and detecting transaction chronology.

At block 424, the document extraction system 215 validates the extracted transaction data 106. In some examples, the document extraction system 215 identifies an opening balance and a closing balance from the extracted transaction data 106 or the extracted ownership data 103. In this example, the document extraction system 215 can add the sum of all credit values included in the extracted transaction data 106 and subtract the sum of all debit values included in the extracted transaction data 106 from the opening balance to determine a predicted closing balance. If the predicted closing balance matches the previously determined closing balance, the extraction of the transaction data 106 is validated. Thereafter, this portion of the process proceeds to completion.

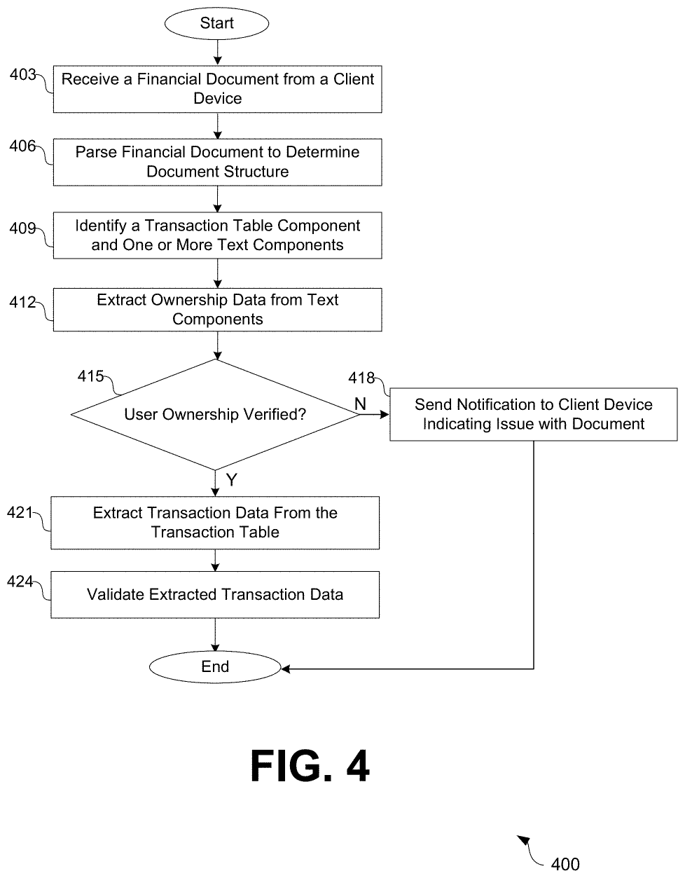

Turning now to FIG. 5, shown is a flowchart 500 that provides one example of the operation of a portion of the document extraction system 215 according to various embodiments. It is understood that the flowchart of FIG. 5 provides merely an example of the many different types of functional arrangements that may be employed to implement the operation of the portion of the document extraction system 215 as described herein. As an alternative, the flowchart of FIG. 5 may be viewed as depicting an example of elements of a method implemented in the computing environment 203 (FIG. 2) according to one or more embodiments.

Beginning with block 503, the document extraction system 215 identifies a table component 115 within a financial document 100. In various examples, the document extraction system 215 parses the document 100 to obtain structured text from the document 100 and to generate a structured representation of the document 100. The document extraction system 215 identifies the table component 115 according to an analysis of the patterns of the structured representation of the document 100. For example, the document extraction system 215 can identify that the text presented in multiple rows and columns is consistent with a transaction table.

At block 506, the document extraction system 215 determines a header location within the identified transaction table of the transaction table component 115. In one or more examples, the document extraction system 215 analyses the text in the transaction table to identify patterns where commonly used header keywords (e.g., ‘Date’, ‘Description’, ‘Debit’, ‘Credit’, ‘Balance’) appear together on the same horizontal line. In various examples, the document extraction system 215 matches the corresponding column header term for each column 130 to one or more keywords that are known to be synonyms. For example, the column header term for a “debit” column 130 may include the term ‘debits’, ‘withdrawals’, and/or other type of synonymous keyword.

In various examples, the document extraction system 215 extracts the text included in the table component 115 line by line and matches the table text against the common header expressions and/or keywords. In various examples, a text line corresponds to text elements having roughly the same y-coordinate and the same font styling information. This process leads to a mapping from the column header term to the index at which it occurs. For example, if a detected header line includes the following sequence ‘Date’, ‘Description’, ‘Deposits’, ‘Withdrawals’, ‘Balance’, then ‘date’ will be assigned the 0th index, “description” will be assigned the 1st index and so on. In some examples, a header 127 can span across multiple lines. In this scenario, the document extraction system 215 considers the group of lines together to judge the presence of a header 127 and then, based on the analysis, creates a mapping between index values and header terms.

At block 509, the document extraction system 215 identifies the column boundaries associated with each header field of the header 127. A column boundary corresponds to the boundaries defining the horizontal start and end of a column 130. In various examples, the document extraction system 215 estimates the inherent alignment of the text under each of the column headers and then calculates the minimum of all left endpoints and maximum of all right endpoints for a particular column 130. Accordingly, the calculated dimensions are used as the width of the column 130.

At block 512, the document extraction system 215 extracts the transaction data 106 in a structured format based at least in part on the table header location and the column boundaries. In various examples, the document extraction system 215 provides the table header location and the column boundaries as inputs to a table parsing library outputs for a table in a structured format. Upon extracting the transaction data 106 from the document 100, the document extraction system 215 post-processes the data. Post processing the data can include organizing transaction types, managing multi-page tables, removing duplicate tables, merging multiline rows within the table, and/or another type of post processing to ensure the extracted transaction data 106 is properly formatted in the structured format.

At block 515, the document extraction system 215 validates the extracted transaction data 106. In some examples, the document extraction system 215 identifies an opening balance and a closing balance from the extracted transaction data 106 or the extracted ownership data 103. In this example, the document extraction system 215 can add the sum of all credit values included in the extracted transaction data 106 and subtract the sum of all debit values included in the extracted transaction data 106 from the opening balance to determine a predicted closing balance. If the predicted closing balance matches the previously determined closing balance, the extraction of the transaction data 106 is validated. Thereafter, this portion of the process proceeds to completion.

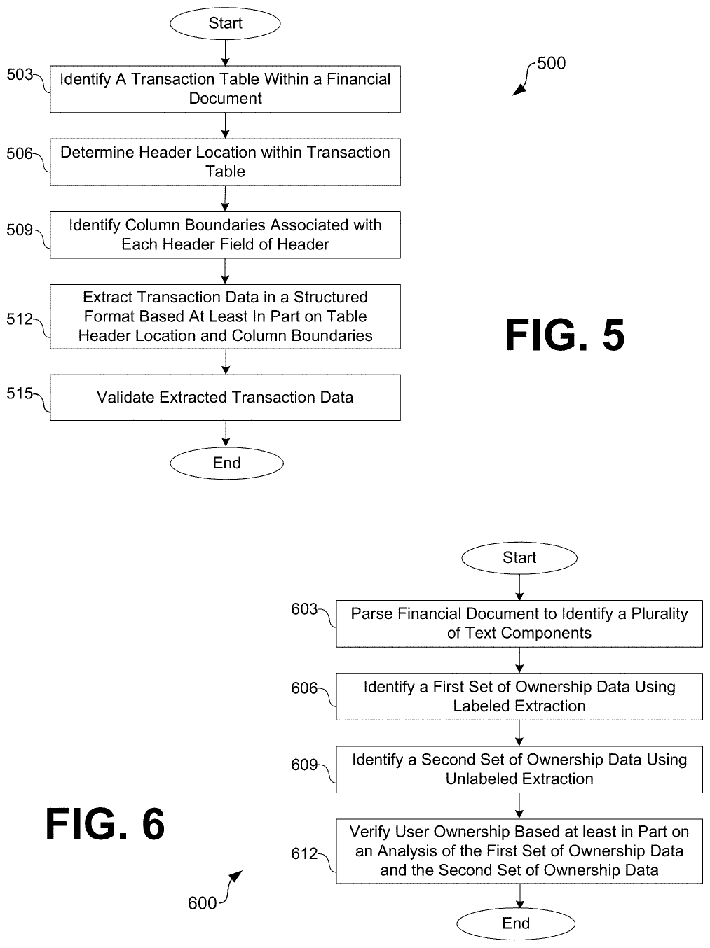

Turning now to FIG. 6, shown is a flowchart 600 that provides one example of the operation of a portion of the document extraction system 215 according to various embodiments. It is understood that the flowchart of FIG. 6 provides merely an example of the many different types of functional arrangements that may be employed to implement the operation of the portion of the document extraction system 215 as described herein. As an alternative, the flowchart of FIG. 6 may be viewed as depicting an example of elements of a method implemented in the computing environment 203 (FIG. 2) according to one or more embodiments.

Beginning with block 603, the document extraction system 215 parses the financial document 100 to identify a plurality of text components 112. The text components 112 are components that contain text that is likely to include the ownership data 103. In various examples, the document extraction system 215 parses the document 100 to obtain structured text from the document 100 and to generate a structured representation of the document 100. The document extraction system 215 identifies the text components 112 according to an analysis of the patterns of the structured representation of the document 100. For example, the document extraction system 215 can identify the candidate text components 112 by identifying the text presented in text blocks at the beginning of the document 100.

At block 606, the document extraction system 215 identifies a first set of ownership data 103 using labeled extraction. Labeled extraction entails the retrieval of key-value pairs from the document 100. For example, an account number may be identified by a label 118 of “Account Number” included in the document 100. For the information being marked with a corresponding label 118, the document extraction system 215 of the present disclosure leverages structural and positional alignment to extract the information as structured key-value pairs. For example, the document extraction system 215, identifies the keys 121 (e.g., labels 118) within the document and then fetches the values 124 from the key's neighborhood. According to various examples, a key 121 is identified by comparing the document text with keywords that are common in the type of document 100 (e.g., bank statement) that is being evaluated. In various examples, the document extraction system 215 determines a key's coordinates in response to finding a match between text in a text block (e.g., a label 118) and a given keyword. Upon determining a key's coordinates, the document extraction system 215 fetches text blocks (e.g., value 124) aligned to it from the six different mappings. Once all key-value pairs are identified and extracted within the document 100, the key-value pairs are added to the first set of ownership data 103 such that the keys 121 are associated with the corresponding value 124.

At block 609, the document extraction system 215 identifies a second set of ownership data using unlabeled extraction. Unlabeled extraction includes an analysis of the text to identify and extract information that is “unlabeled” (e.g., not in the form of key-value) in the document. This information may include an owner address, an owner name, a statement period, and/or other type of information that may not be explicitly labeled in the document. In various examples, the document extraction system 215 identifies the second set of ownership data by applying NER on the unlabeled text to identify relevant entities such as date, location, person, organization, etc.

At block 612, the document extraction system 215 verifies whether the user submitting the documents is the owner of the document 100 based on an analysis of the first set of ownership data 103 and the second set of ownership data 103. In various examples, the document extraction system 215 compares the extracted ownership data 103 (including the account summary data) with the user data 227 to determine if the details extracted from the document 100 match the details included in the user data 227. For example, the user data 227 can include an owner name and the document extraction system 215 can compare the owner name in the user data 227 with the owner name included in the extracted ownership data 103. In one or more examples, if the extracted ownership data 103 matches the user data 227, the document extraction system 215 generates and sends a notification to the client device 206 associated with the user indicating that the documents 100 have been verified. However, if the extracted ownership data 103 fails to match the user data 227, the document extraction system 215 generates and sends a notification to the client device 206 associated with the user indicating the documents could not be verified. Thereafter, this portion of the process proceeds to completion.

A number of software components previously discussed are stored in the memory of the respective computing devices and are executable by the processor respective computing devices. In this respect, the term “executable” means a program file that can be in a form that can ultimately be run by the processor. Examples of executable programs can be a compiled program that can be translated into machine code in a format that can be loaded into a random access portion of the memory and run by the processor, source code that can be expressed in proper format such as object code that can be capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages could be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X and/or Y; X and/or Z; Y and/or Z; X, Y, and/or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
at least one computing device comprising at least one processor and at least one memory; and
machine-readable instructions stored in the at least one memory that, when executed by the at least one processor, cause the at least one computing device to at least:
obtain a document for processing;
identify a plurality of document components within the document, the plurality of document components comprising a table and a plurality of text blocks;
extract transaction data from the table in a structured format;
verify the transaction data that is extracted;
extract ownership information from the plurality of text blocks; and
verify ownership of the document by a user based at least in part on the ownership information.

2. The system of claim 1, wherein, when executed, the machine-readable instructions further cause the at least one computing device to at least receive an underwriting request associated with the user from a client device, the underwriting request comprising the document.

3. The system of claim 2, wherein, when executed, the machine-readable instructions further cause the at least one computing device to at least:
determine a table header location of a table header from the table, the table header comprising header text associated with a plurality of header entries;
determine respective column boundaries for individual columns of a plurality of columns corresponding to the plurality of header entries; and
the transaction data being extracted from the transaction table based at least in part on the table header location and the respective column boundaries.

4. The system of claim 1, wherein, when executed, the machine-readable instructions further cause the at least one computing device to at least:
determine a starting balance value and an ending balance value based at least in part on at least one of the transaction data or the ownership information;
identify a sum of credit values included in the transaction data;
identify a sum of debit values included the transaction data;
determine a predicted ending balance by adding the sum of credit values and subtracting the sum of debit values from the starting balance value; and
the transaction data being verified based at least in part on the predicted ending balance matching the ending balance value.

5. The system of claim 1, wherein the ownership information comprises a first type of ownership information and a second type of ownership information, the first type of ownership information being labeled with an identifying label term in a first text block of the plurality of text blocks, and the second type of ownership information being unlabeled in a second text block of the plurality of text blocks.

6. The system of claim 5, wherein, when executed, the machine-readable instructions cause the at least one computing device to at least:
detect the identifying label term included in text of the first text block;
determining a label value associated with the identifying label term based at least in part on a positional alignment associated with the identifying label term and the label value; and
extract the label value from the document, the label value being included in the first type of ownership information in association with the identifying label term.

7. The system of claim 5, wherein, when executed, the machine-readable instructions cause the at least one computing device to at least:
identify at least one named entity included in text included in the second text block;
identify a label type associated with the second text block based at least in part on the at least one named entity; and
associate the text included in the second text block with the label type, the text corresponding to the second type of ownership information.

8. A method, comprising:
obtaining a document from a client device for processing;
identifying a transaction table within the document obtained for processing;
determining a header location of a header within the transaction table, the header comprising a plurality of header terms;
determining respective column boundaries for individual columns of a plurality of columns, the individual columns being associated with a respective header term of the plurality of header terms;
extracting transaction data in a structured format based at least in part on the header location and the respective column boundaries; and
validating the transaction data that is extracted.

9. The method of claim 8, further comprising:
identifying a last balance value in the transaction data;
identifying a first balance value in the transaction data;
determining a predicted closing balance value according to the first balance value, a sum of debit values included in the transaction data, and a sum of credit values included in the transaction data; and
validating the transaction data in response to the predicted closing balance value matching the last balance value.

10. The method of claim 8, wherein the document comprises a plurality of pages and the transaction table spans over more than one page of the plurality of pages.

11. The method of claim 8, further comprising:
determining that a transaction included in the transaction data spans a plurality of lines in a table row of a plurality of table rows in the transaction table; and
associating the plurality of lines with a particular transaction entry of a plurality of transaction entries in the structured format.

12. The method of claim 8, wherein the structured format comprises a delimited format in one of a spreadsheet, a comma-separated values (CSV) document, a hypertext markup language (HTML) document, or an extensible markup language (XML) document.

13. The method of claim 8, further comprising:
identifying a plurality of text blocks within the document;
extracting user data from the text blocks, the user data comprising at least an owner name, an owner address, a transaction account number, and a statement period; and
verifying ownership of a user claiming ownership of the document based at least in part on an analysis of the user data.

14. The method of claim 13, further comprising:
generating an error notification in response to being unable to verify ownership of the document based at least in part on the analysis of the user data; and
sending the error notification to the client device associated with the user.

15. A non-transitory computer-readable medium embodying a program executable by at least one processor, wherein the program, when executed, causes the at least one processor to at least:
obtain a document from a client device for processing;
parse the document to identify a plurality of text components;
identify a first type of ownership information from a first text component of the plurality of text components based at least in part on a proximity of the first type of ownership information with a label term in the first text component, the first type of ownership information being labeled by the label term in the document;
identify a second type of ownership information from a second text component of the plurality of text components based at least in part on an analysis of text included in the second text component, the second type of ownership information being unlabeled in the document; and
extract the first type of ownership information and the second type of ownership information from the document.

16. The non-transitory computer-readable medium of claim 15, wherein, when executed, the program causes the at least one processor to at least verify a user associated with the document based least in part on an analysis of the first type of ownership information and the second type of ownership information.

17. The non-transitory computer-readable medium of claim 15, wherein, when executed, the program causes the at least one processor to at least:
identify at least one named entity included in text of the second text component corresponding to the second type of ownership information;
identify a label type associated with the text based at least in part on the at least one named entity; and
associate the text included in the second text component with the label type.

18. The non-transitory computer-readable medium of claim 15, wherein, when executed, the program causes the at least one processor to at least: parse the document to identify a transaction table.

19. The non-transitory computer-readable medium of claim 18, wherein when executed, the program causes the at least one processor to at least:
extract transaction data from the transaction table in a structured format; and
validate the transaction data based at least in part on an analysis of a sum of credit values included in the transaction data, a sum of debit values included in the transaction data, a beginning balance, and a closing balance.

20. The non-transitory computer-readable medium of claim 19, wherein, when executed, the program further causes the at least one processor to at least:
receive an underwriting request from the client device associated with a user, the underwriting request comprising the document; and
approve the underwriting request based at least in part on an analysis of the transaction data.
